(19) United States
(12) Patent Application Publication
(10) Pub. No.: US 2005/0257235 A1
(43) Pub. Date: Nov. 17, 2005

(54) Remote interview system for job seeker and employer

(75) Inventor: Wen-Shiung Lin, Taipei (TW)

Correspondence Address: TROXELL LAW OFFICE PLLC, SUITE 1404, 5205 LEESBURG PIKE, FALLS CHURCH, VA, 22041, US

(73) Assignee: Global Chinese Internet Corp.

(21) Appl. No.: 11/126,173

(22) Filed: May 11, 2005

(30) Foreign Application Priority Data
May 13, 2004 (TW) 0093207485

(51) Int. Cl. G06F 7/00

(52) U.S. Cl. 725/1

(57) ABSTRACT

The present invention provides a remote interview system with computers connected by a network connection facility to hold an interview over the Internet for fast and efficient job application and employment regardless of geographic limitations even through any pc at home worldwide conveniently and causally.

### FIELD OF THE INVENTION

The present invention relates to an interview system; more particularly, relates to a network interview system for holding an interview on the Internet for fast job application and fast employment.

### DESCRIPTION OF THE RELATED ART

Concerning employment and job application, with the help of a website of a human resource bank, the efficiency is quite good with convenience; yet, the contents showed on the website include only static resumes and photos. After a preliminary examination for filtering, an employer has to arrange an interview with each job seeker to decide whether the job seeker is qualified. And, as is known, the interview takes time and effort quite much. As to the job seeker, traffics to prearranged places for interviews have to be taken for finding a proper job, where the time and effort taken is hard to calculate. So, the prior art does not fulfill users' requests on actual use.

### SUMMARY OF THE INVENTION

Therefore, the main purpose of the present invention is to provide a remote interview system for a job seeker and an employer to hold an interview having video and audio between a computer for the job seeker and another computer for the employer while providing the functions of arranging interviews, subscribing interview arrangements, etc. for the both sides with an interface of a website after establishing a transferring path for the video and audio data so that a network interview is provided with a high efficiency together with preventing from the inconvenience of traffic.

Another purpose of the present invention is for the job seeker and the employer to be logged on through an interface to an interview-processing computer to hold an interview having video and audio on the Internet after a preliminary examination.

Still another purpose of the present invention is to integrate an auto-replier email system and related functions of monitoring, recording an interview into a historical video data, etc. into an interview-processing computer to notify either side of an interview arrangement regarding the rearrangement or the cancellation of the interview arrangement, and to acquire a historical video data of an interview.

To achieve the above purposes, the present invention is a remote interview system for a job seeker and an employer, comprising an employer end, a job-seeker end and a website, where both the employer end and the job-seeker end are each a multi-media computer capable of accessing the Internet with a video camera, a speaker and a microphone; and the website is located on an interview-processing computer to response requirements from the employer end and the job-seeker end, including, at the employer end, publishing job openings and available interview arrangements by an employer and, at the job-seeker end, subscribing an interview arrangement by a job seeker so that the interview is held at a prearranged time by establishing a bi-directional channel for video and audio data between the employer end and the job-seeker end after the job-seeker passes a preliminary examination. Accordingly, a novel remote interview system for a job seeker and an employer is obtained.

### BRIEF DESCRIPTIONS OF THE DRAWINGS

The present invention will be better understood from the following detailed description of the preferred embodiment according to the present invention, taken in con junction with the accompanying drawings, in which

FIG. 1 is a view of a system diagram according to the present invention;

FIG. 2 is a view of a flow chart of a remote interview system according to the present invention;

FIG. 3A a view of an operational flow chart at an employer end of a remote interview system according to the present invention; and

FIG. 3B is a view of an operational flow chart at a job-seeker end of a remote interview system according to the present invention.

### DESCRIPTION OF THE PREFERRED EMBODIMENTS

The following description of the preferred embodiment is provided to understand the features and the structures of the present invention.

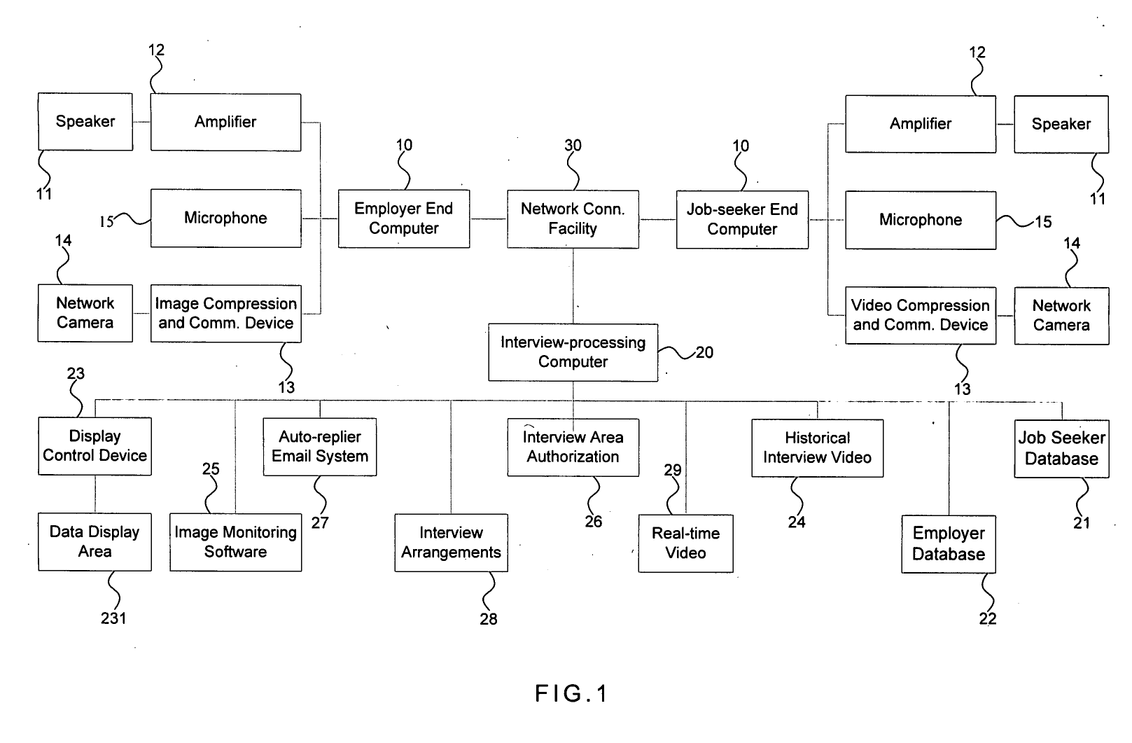

Please refer to FIG. 1, which is a view of a system diagram according to the present invention. As shown in the figure, a remote interview system according to the present invention comprises computers 10 of an employer end and a job-seeker end at the upper left and upper right corners of the figure and an interview-processing computer 20 at the lower part. Therein, each of the computers at the employer end and the job-seeker end comprises a speaker 11, an amplifier 12, an image compression and communication device 13, a network camera 14 (e.g. a video camera) and a microphone 15 being connected to the interview-processing computer 20 through a network connection facility 30 (e.g. a computer). And, the interview-processing computer 20 comprises a job seeker database 21, an employer database 22, a display control device 23, a data display area 231 on the monitor, an image monitoring software 25 and an auto-replier email system 27.

Furthermore, the interview-processing computer 20 with its components helps the connected employer end and job-seeker end to perfect functions of the remote interview system, including setting up available interview arrangements 28, setting up an interview area authorization 26, displaying real-time video 29, inquiring and replaying a historical interview video 24, and sending an automatic notification through an auto-replier email system 27 when an interview appointment is canceled or rearranged. Hence, a novel remote interview system for a job seeker and an employer is obtained.

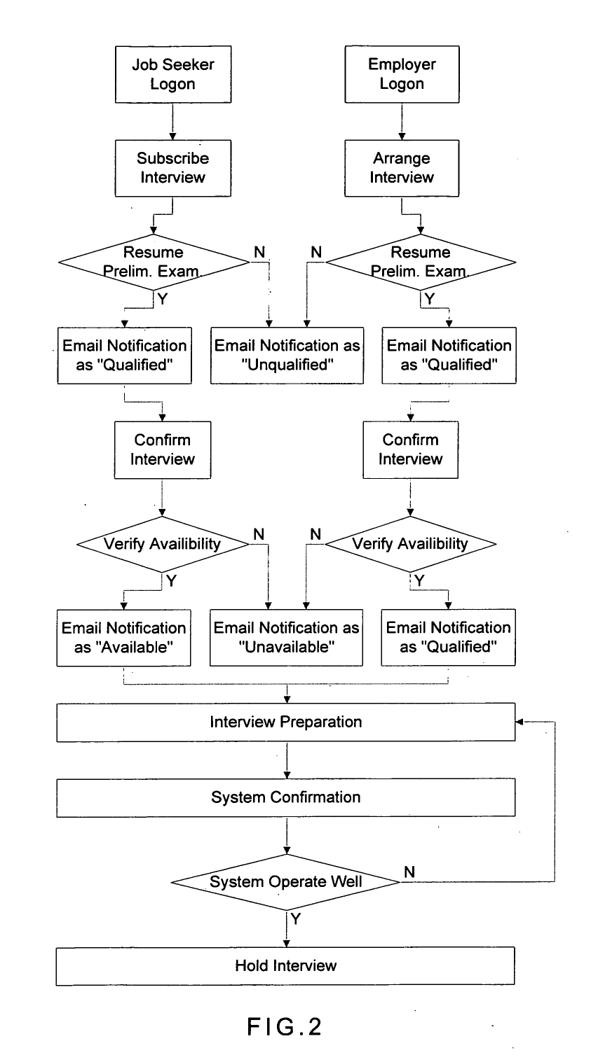

Please refer to FIG. 2, which is a view of a flow chart of a remote interview system according to the present invention. As shown in the figure, after an employer at the employer end or a job-seeker at the job seeker end is logged on to a home page on an interview-processing computer, functions such as setting up job openings, arranging interviews, subscribing interview arrangements, etc. can be processed following the tips displayed on the screen at the employer end or the job-seeker end. When an interview arrangement is subscribed by the job seeker, a static resume of the job seeker is preliminarily examined by the employer. If the job seeker fails in the examination, he will be notified by an email. If the job seeker passes, he will be notified by an email too about the subscription of the interview arrangement with the employer. When the job seeker logs on for the next time, the interface of the home page on the interview-processing computer shows a button of “Please enter for an interview” or an eye-catching hint saying so. After receiving confirmations from both sides for the interview arrangement, an interview is held through a bi-directional communication by computers at both sides at a prearranged time while the system operates well. If either side rearranges or cancels the interview arrangement, an email will be sent to notify the other side. Hence, an operational flow of the novel remote interview system according to the present invention is obtained.

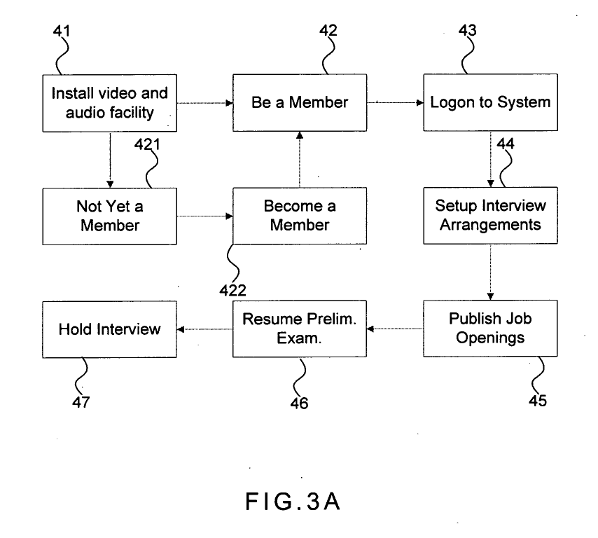

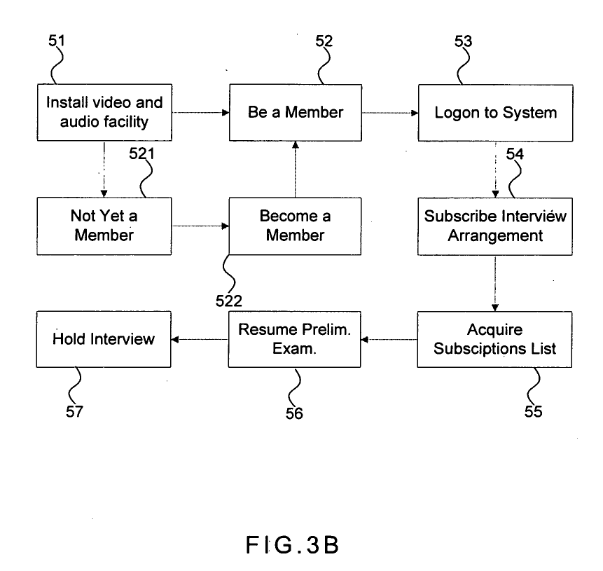

Please refer to FIG. 3A, which is a view of an operational flow chart at an employer end of a remote interview system according to the present invention. As shown in the figure, in an actual usage, a video and audio facility is installed 41 at the employer end. An employer at the employer end has to be a member 42 to use the system. If the employer is not yet a member 421, he has to become a member 422 at first. The employer is then logged on to the remote interview system 43 to setup available interview arrangements 44 and publish job openings 45 on a website of the remote interview system. When a job seeker applies for one of the job openings, a resume of the job seeker is resume preliminarily examined 46 by the employer. If the resume of the job seeker passes the examination, an interview between the job seeker and the employer is then held 47 at a prearranged time.

Please refer to FIG. 3B, which is a view of an operational flow chart at a job-seeker end of a remote interview system according to the present invention. As shown in the figure, concerning the operational flow chart at the job seeker end, a video and audio facility is installed 51. A job seeker at the job-seeker end has to be a member 52 to use the system. If the job seeker is not yet a member 521, he has to become a member 522 at first. The job seeker is then logged on to the remote interview system 53 to subscribe an interview arrangement 54 for an available job opening and acquire the list of all arrangements subscribed 55 on a website of the remote interview system. A resume of the job seeker is then preliminarily examined 56 by the employer. If the resume of the job seeker passes the examination, an interview between the job seeker and the employer is then held 57 at a prearranged time.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

1. A remote interview system for a job seeker and an employer, comprising:
an employer end, a multi-media computer capable of accessing the Internet with a video camera, a speaker and a microphone;
a job-seeker end, a multi-media computer capable of accessing the Internet with a video camera, a speaker and a microphone; and
a website on an interview-processing computer to response requirements from said employer end and said job-seeker end, an employer at said employer end publishing job openings and available interview arrangements on said website, a job seeker at said job-seeker end subscribing one of said interview arrangements on said website,
wherein an interview according to said interview arrangement subscribed is held at a prearranged time by establishing a bi-directional video-and-audio channel between said employer end and said job-seeker end after said job seeker passes a preliminary examination.

2. The interview system according to claim 1,
wherein an auto-replier email system is included in said interview-processing computer to automatically send an email to notify said employer end after a preliminary examination;
wherein, when a modification is done to said interview arrangement subscribed by an end related to said interview arrangement, said auto-replier email system automatically sends an email to notify the other end related to said interview arrangement;
wherein said one end and said the other end are each respectively selected from a group consisting of said employer and said job seeker; and
wherein said modification is selected from a group consisting of a cancellation and a rearrangement.

3. The interview system according to claim 1, wherein said interview-processing computer further comprises a job seeker database and an employer database.

4. The interview system according to claim 1,
wherein said interview-processing computer further provide a real-time video of a remote interview; and
wherein said interview-processing computer further provides a video of a historical interview according to an inquiry.
